(19) United States
(12) Patent Application Publication
(10) Pub. No.: US 2026/0119873 A1
(43) Pub. Date: Apr. 30, 2026

(54) EFFICIENT GRAPH NEURAL NETWORK TRAINING THROUGH GRAPH STRUCTURE-AWARE RANDOMIZED MINI-BATCHING

(71) Applicant: NVIDIA Corporation, Santa Clara, CA (US)

(72) Inventors: Vignesh Balaji, San Jose, CA (US); Haggai Maron, Rehovot (IL)

(21) Appl. No.: 19/037,604

(22) Filed: Jan. 27, 2025

Related U.S. Application Data
(60) Provisional application No. 63/713,956, filed on Oct. 30, 2024.

(51) Int. Cl. G06N 3/082; G06N 3/10

(52) U.S. Cl. CPC G06N 3/082; G06N 3/10

(57) ABSTRACT

Systems and methods are disclosed that perform efficient training of a graph neural network (GNN) using graph structure-aware randomized mini-batching. For example, nodes from a graph may be obtained. Subsequently, the nodes of the graph may be grouped into communities and then the order of the communities as well as the nodes within each of the communities may be shuffled. Based on shuffling the order of the communities and the nodes within the communities, mini-batches for training the GNN may be determined. Following, based on a sampling bias, a sub-graph may be constructed for each of the mini-batches to obtain a plurality of sub-graphs. The sampling bias may indicate a bias for sampling intra-connections instead of inter-connections. After, the GNN may be trained based on the constructed sub-graphs.

### CLAIM OF PRIORITY

This application claims the benefit of U.S. Provisional Application No. 63/713,956 (Attorney Docket No. 515133) titled “Efficient Graph Neural Network training through graph structure-aware randomized mini-batching,” filed Oct. 30, 2024, the entire contents of which is incorporated herein by reference.

### BACKGROUND

Graphs are a primary type of data in many important applications ranging from social network analysis to financial fraud detection with typical graphs including millions of nodes and billions of edges. Graph neural networks (GNNs) have emerged as the primary tool for analyzing such graphs, but the scale of inputs poses significant computational challenges as the graph data far exceeds available memory capacity on graphics processing units (GPUs). A common, conventional approach to addressing this limitation of GNN training is mini-batching, where the graph is divided into smaller chunks on which the model is then trained sequentially.

GNN training via mini-batching faces two competing requirements. Specifically, randomization during training is essential for model accuracy and convergence, leading to widespread adoption of random sampling in GNN frameworks. However, graph analytics research has shown that exploiting graph structure through node reordering may significantly improve cache efficiency. This is particularly effective for real-world graphs that exhibit community structure, where nodes are densely connected within communities but sparsely connected between them. While this community-aware approach has proven effective for GNN inference, its benefits are lost during training due to random sampling destroying locality. The result is a clear trade-off: random mini-batching achieves good accuracy and convergence but with slow per-epoch computation, while structure-based mini-batching enables fast per-epoch computation but leads to slower convergence and reduced accuracy. This creates a significant performance dilemma for practitioners and as such, there is a need for addressing these issues and/or other issues associated with the prior art.

### SUMMARY

Embodiments of the present disclosure relate to efficient GNN training through graph structure-aware randomized mini-batching. For instance, systems and methods are disclosed that describe a community-structure-aware randomized mini batching (COMM-RAND) process that bridges the gap between the above two extremes. As mentioned above, processing massive graphs (e.g., social network graphs that include hundreds of millions of nodes and edges) poses significant computational challenges as these graphs far exceed available memory capacity. To address this limitation, mini-batching, which is a procedure in which the graph is effectively partitioned into several parts that are trained independently, has become the predominant approach for training GNNs on large graphs. However, designing effective mini-batch construction mechanisms faces a fundamental tension between two competing objectives. For example, it has been demonstrated that randomization in mini-batch creation is crucial for training convergence and model accuracy, but these randomization schemes are often agnostic to the structural properties of the graph and thus result in highly irregular memory access patterns during GNN training that make sub-optimal use of on-chip caches on graphics processing units (GPUs). On the other hand, purely structure-oriented deterministic approaches to mini-batching offer great runtime performance but lead to reduced accuracy and slower convergence.

In contrast to conventional systems, such as those described above, embodiments of the present disclosure describe a COMM-RAND process (e.g., a mini-batch construction process) that may include: 1) structure-aware randomness in root node ordering that biases mini-batches toward computationally efficient patterns while maintaining sufficient randomization for convergence, and 2) adaptive community-aware neighborhood sampling that controls the level of structural bias when expanding sub-graphs from root nodes. By using the COMM-RAND process, this enables the ability to navigate the interplay between pure randomness and pure structural awareness, thus leading to more efficient training while maintaining nearly identical accuracy.

For example, in a mini-batch GNN training pipeline, two major steps are performed to pre-process a training set (e.g., one or more nodes from a graph such as a subset or portion of nodes from a graph) prior to training the GNN. In a first step, the nodes of the graph may be divided across different batches (e.g., mini-batches), and each mini-batch may include a subset of the nodes of the graph, which are referred to as the root nodes. In some instances, this step may be referred to as mapping root nodes into batches. In a second step, a sub-graph is constructed for each batch by traversing the L-hop neighborhoods for all of the root nodes within the batch. The GNNs are then trained using the constructed subgraphs. In order to navigate the interplay between pure randomness and pure structural awareness, the COMM-RAND process improves upon the two above steps. The COMM-RAND process is described in further detail below.

In an embodiment, a computer-implemented method for performing efficient training of a GNN using graph structure-aware randomized mini-batching is provided. The method comprises obtaining a plurality of nodes from a graph for training the GNN and grouping the plurality of nodes into a plurality of communities. Each of the of the plurality of communities comprises a subset of the plurality of nodes from the graph. The method further comprises shuffling an order of the plurality of communities and the subsets of the plurality of nodes within each of the plurality of communities. Based on shuffling the order of the plurality of communities and the subsets of the plurality of nodes within each of the plurality of communities, the method includes determining a plurality of mini-batches for training the GNN and each of the plurality of mini-batches comprises one or more nodes from the plurality of nodes from the graph. The method also includes training the GNN based on the plurality of determined mini-batches.

### BRIEF DESCRIPTION OF THE DRAWINGS

The present systems and methods for efficient GNN training through graph structure-aware randomized mini-batching are described in detail below with reference to the attached drawing figures, wherein:

FIG. 1A illustrates a COMM-RAND process that performs a step for biased mapping of root nodes to batches and a step for biased neighborhood sampling to construct the sub-graphs, in accordance with an embodiment;

FIG. 1B shows a portion of a graph after the nodes have been grouped into communities and then reordered using a graph reordering process, in accordance with an embodiment;

FIG. 2A shows an example shuffling operation that is used by the COMM-RAND process to shuffle the nodes, in accordance with an embodiment;

FIG. 2B shows another example shuffling operation that utilizes a community-mixing knob, in accordance with an embodiment;

FIG. 2C shows the grouping of the shuffled nodes and communities into batches (e.g., mini-batches) based on a batch size, in accordance with an embodiment;

FIG. 2D shows an example of the COMM-RAND process performing biased neighborhood sampling to construct a sub-graph, in accordance with an embodiment.

FIG. 3 provides a flow diagram illustrating a method for performing efficient training of a GNN using graph structure-aware randomized mini-batching, in accordance with an embodiment;

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed herein that relate to efficient GNN training through graph structure-aware randomized mini-batching, and in particular, to a COMM-RAND process that includes: 1) structure-aware randomness in root node ordering that biases mini-batches toward computationally efficient patterns while maintaining sufficient randomization for convergence, and 2) adaptive community-aware neighborhood sampling that controls the level of structural bias when expanding sub-graphs from root nodes.

For instance, conventional mini-batch construction policies may largely ignore efficiency considerations of GNN training. In particular, existing mini-batching techniques employ randomization schemes to improve accuracy and convergence. However, these randomization schemes are often agnostic to the structural properties of the graph (e.g., the community structure of the graph), resulting in highly irregular memory access patterns during GNN training that make sub-optimal use of on-chip caches on GPUs. On the other hand, while deterministic mini-batching based solely on graph structure delivers fast runtime performance, the lack of randomness compromises both the final model accuracy and training convergence speed. As such, embodiments of the present disclosure describe a COMM-RAND process that bridges the gap between the above extremes. The COMM-RAND process utilizes the space between pure randomness and pure graph structural awareness during mini-batch construction, which leads to significantly more efficient training yielding similar accuracy. The COMM-RAND process was evaluated in four widely-adopted graph-learning benchmarks and it was shown that the COMM-RAND process reduces the GNN training time by up to 1.9 times (1.43 times on average) while maintaining the accuracy within 1% point (e.g., within 0.7% points) compared to conventional random mini-batching approaches.

In particular, as mentioned above, the two main steps of mini-batch construction include partitioning the nodes in the training set across batches and building a sub-graph by sampling a subset of the neighborhood nodes within each batch. Embodiments of the present disclosure develop a constrained form of randomization that is aware of the community structure in graphs and use it to build mini-batches that are effective at improving per-epoch processing (e.g., due to community-bias) while also maintaining good convergence (e.g., due to randomization). Furthermore, the COMM-RAND process exposes knobs that allow controlling the level of structural-bias and randomness, which enables practitioners to explore the right balance between per-epoch processing and convergence rate to improve the overall GNN training time.

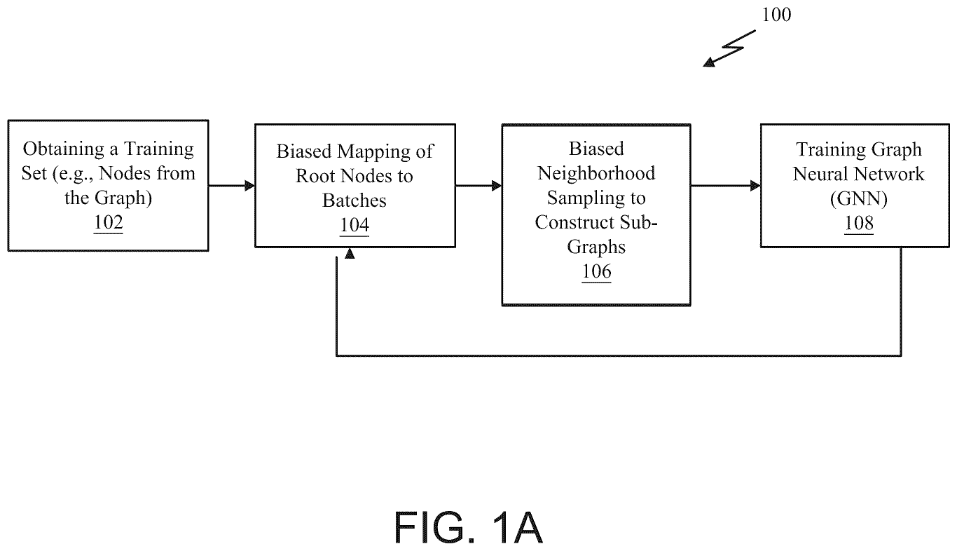

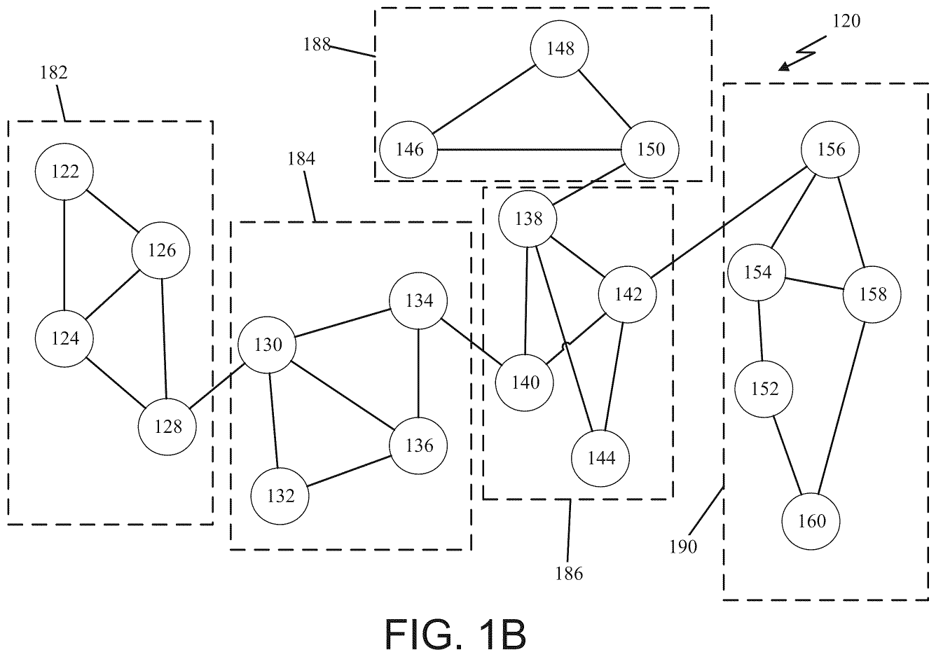

FIG. 1A illustrates a COMM-RAND process 100 that performs a step 104 for biased mapping of root nodes to batches and a step 106 for biased neighborhood sampling to construct the sub-graphs, in accordance with an embodiment. For example, FIG. 1A illustrates a COMM-RAND process 100 that includes a step 102 for obtaining a training set (e.g., nodes from a graph such as a portion or section of nodes from a graph), a step 104 for biased mapping of root nodes to batches, a step 106 for biased neighborhood sampling to construct sub-graphs, and a step 108 for training the GNN. Each step of the COMM-RAND process 100, described herein, comprises a computing process that may be performed using any combination of hardware, firmware, and/or software. For instance, various functions may be carried out by a processor executing instructions stored in memory. The COMM-RAND process 100 may also be embodied as computer-usable instructions stored on computer storage media. The COMM-RAND process 100 may be provided by a standalone application, a service or hosted service (standalone or in combination with another hosted service), or a plug-in to another product, to name a few. In addition, the COMM-RAND process 100 may be executed by any one system, or any combination of systems, including, but not limited to, those described herein. Furthermore, persons of ordinary skill in the art will understand that any system that performs the COMM-RAND process 100 is within the scope and spirit of embodiments of the present disclosure.

More illustrative information will now be set forth. It should be strongly noted that the following information is set forth for illustrative purposes and should not be construed as limiting in any manner. Any of the following features may be optionally incorporated with or without the exclusion of other features described.

For example, uniform random mini-batching and entirely community based mini-batching represent extreme points on the GNN training convergence versus per-epoch runtime trade-off space. As such, embodiments of the present disclosure explores the intermediate points of the trade-off space using community structure-biased randomization (the COMM-RAND process 100) for minibatch construction. Below, the COMM-RAND process 100 proposes community aware randomization schemes for the two steps of minibatch construction that allows combining the convergence benefits of randomization with the data reuse benefits of structure-awareness. Embodiments of the present disclosure may utilize the community membership of nodes in the graph, which may be available after performing community-based graph reordering.

In some instances, a computing platform may be configured to train a GNN, and may utilize the COMM-RAND process 100. However, it should be understood that the computing platform and other arrangements described herein are set forth only as examples. Other arrangements and elements (e.g., machines, interfaces, functions, orders, groupings of functions, etc.) may be used in addition to or instead of those described herein, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the computing platform is within the scope and spirit of embodiments of the present disclosure.

In operation, at step 102, a training set (e.g., nodes of a graph such as a subset or portion of the nodes of the graph) may be obtained. For example, a graph that comprises a plurality of nodes and edges that indicate connections between the nodes may be obtained. Subsequently, after obtaining the graph and using a community process and a graph reordering process, the computing platform may group the nodes into communities and then reorder (e.g., renumber) the nodes of the graph. This is described in FIG. 1B.

FIG. 1B shows a portion of a graph 120 after the nodes 122-160 have been grouped into communities and then reordered using a graph reordering process, in accordance with an embodiment. In some examples, an objective of the graph reordering process may be to ensure that members of a community are assigned to “consecutive” identifiers (IDs). For example, after obtaining a subset of nodes, the nodes 122-160 may be grouped into communities such as the communities 182-190. Subsequently, the nodes may be renumbered using an ID. For instance, a training set may include the nodes 122-160 and each of the nodes 122-160 may be associated with an initial node ID such as the node 122 having a node ID of “10”, the node 124 having a node ID of “5”, the node 126 having a node ID of “3”, and so on. After grouping the nodes 122-160 into communities 182-190, each of the nodes 122-160 may be renumbered such as from “0” to “19”. For example, a first node from the first community 182 (e.g., the node 122) may be renumbered from a node ID of “10” to a node ID of “0”. A second node from the first community 182 (e.g., the node 124) may be renumbered from a node ID of “5” to a node ID of “1”. This may continue for the rest of the nodes 126-160 of the portion of the graph 120 (e.g., the node 160 from the fifth community 190 may be renumbered to have a node ID of “19”).

In other words, in some embodiments, the computing platform may use a community process that groups the nodes 122-160 into communities 182-190. For instance, the nodes 122-128 are grouped into a first community 182, the nodes 130-136 are grouped into a second community 184, the nodes 138-144 are grouped into a third community 186, the nodes 146-150 are grouped into a fourth community 188, and the nodes 152-160 are grouped into a fifth community 190. Following, the computing platform may use a graph reordering process to renumber the nodes of the training set such that the node IDs for the nodes 122-160 are from “0” to “19”. The computing platform may use any type of community process to group the nodes from the training set (e.g., the nodes 122-160) into communities (e.g., the communities 192-190) including, but not limited to the community process described in Balaji et al. in “Community-based Matrix Reordering for Sparse Linear Algebra Optimization,” 2023 IEEE International Symposium on Performance Analysis of Systems and Software (ISPASS), Raleigh, NC, USA, 2023, pp. 214-223, doi: 10.1109/ISPASS57527.2023.00029 (“Balaji”), which is incorporated by reference herein. The computing platform may use any type of graph reordering process to renumber the nodes of the training set including, but not limited to the graph reordering process described in Arai et al. in “Rabbit Order: Just-in-Time Parallel Reordering for Fast Graph Analysis,” 2016 IEEE International Parallel and Distributed Processing Symposium (IPDPS), Chicago, IL, USA, 2016, pp. 22-31, doi: 10.1109/IPDPS.2016.110, which is incorporated by reference herein.

The portion of the graph 120, which includes twenty nodes 122-160, is merely exemplary and shows a simplified real-world graph. For example, as mentioned above, real-world graphs may include numerous nodes and edges such as hundreds of millions of nodes and edges. Therefore, because real-world graphs exhibit strong structural properties such as a community structure, the COMM-RAND process 100 may leverage the community structure to improve performance on graph-processing applications. Specifically, to improve performance, the COMM-RANND process 100 may group the nodes into communities and then perform graph reordering. For instance, the data footprint of typical graphs may often exceed the limited cache capacity available in processors. In an unordered graph, the sparsity pattern may lead to a highly irregular memory access pattern that often misses in the cache and may require performing expensive main-memory accesses. In a community-reordered graphs (e.g., shown in FIG. 1B), the structured sparsity pattern indicates that members of a community (e.g., nodes 122-128 that belong to the first community 182) are likely to be accessed together, which leads to high spatial and temporal locality. Since the data footprint of communities are smaller than the entire graph, community-based reordering improves the likelihood of data accesses being served from the processor's cache which improves overall performance.

In some examples, performing the graph reordering and/or identifying the communities may be optional. For example, in some embodiments, instead of performing the graph reordering, the computing platform may obtain a subset of nodes from the graph and group the nodes into communities. However, the computing platform might not perform graph renumbering. In other words, the computing platform may perform steps 104 and 106 based on grouping the subset of nodes from the graph into communities without renumbering the nodes. To put it another way, in some instances, the training set that is obtained at step 102 and provided to step 104 may comprise a subset of nodes from the graph after the grouping the nodes into communities and performing the graph reordering. In other instances, the training set that is obtained at step 102 and provided to step 104 may include the subset of nodes from the graph that are grouped into communities, but not renumbered (e.g., based on the example above, the first node 122 may continue to have the node ID of “10”instead of the node ID of “0”).

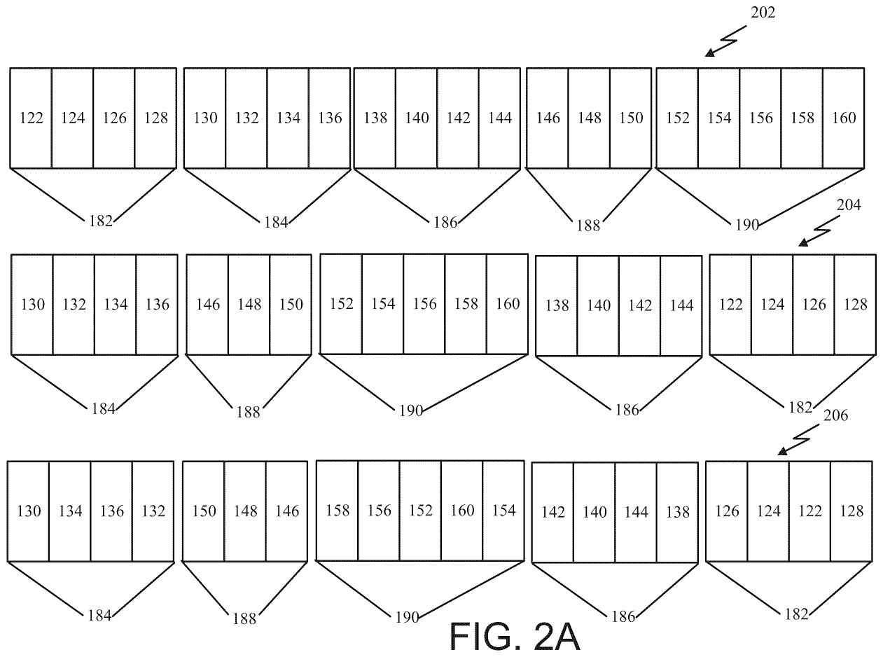

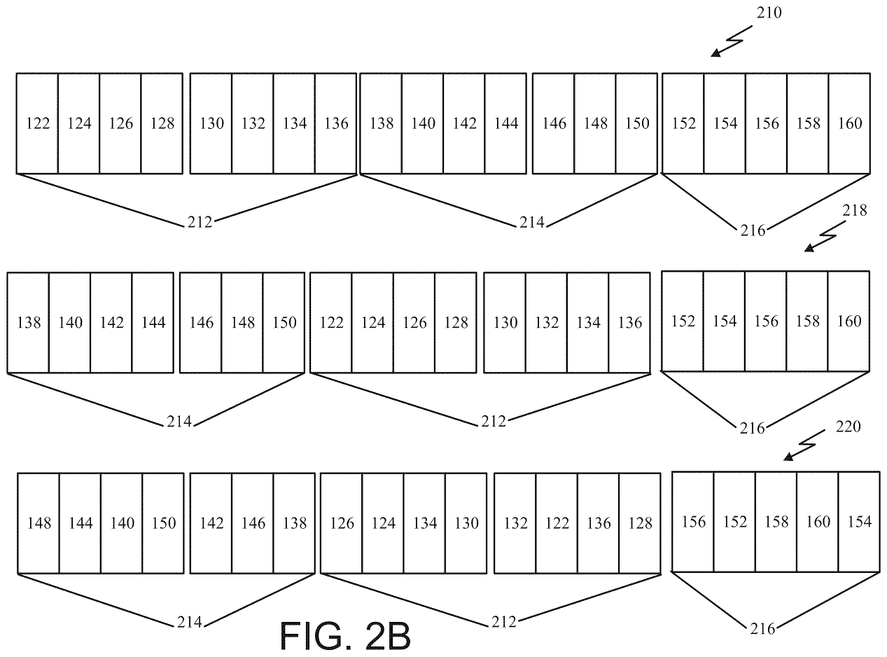

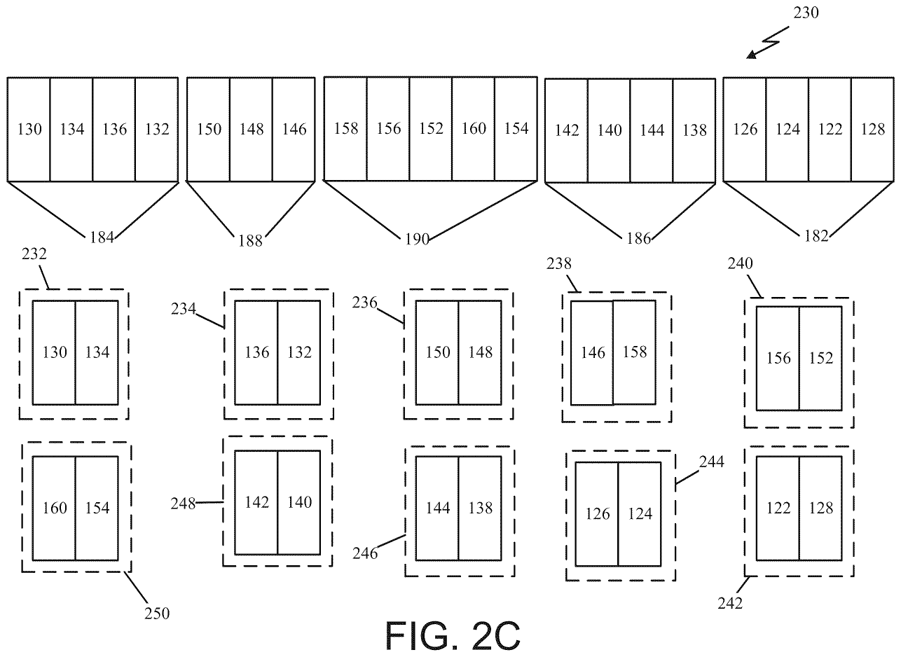

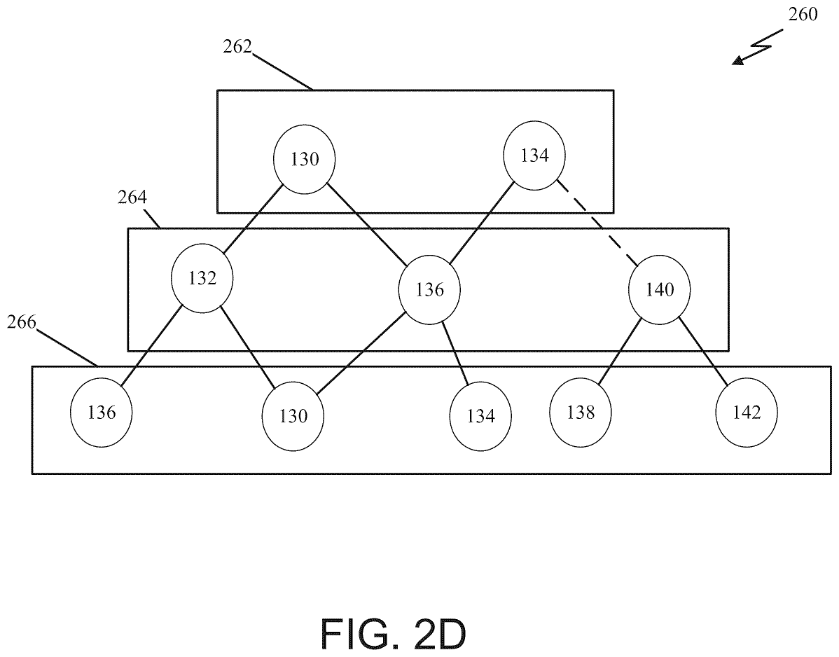

At step 104, the computing platform may perform biased mapping of root nodes to batches. For example, the computing platform may use a shuffling operation to shuffle the nodes 122-160 that are within the communities 182-190. This is described in further detail in FIGS. 2A and 2B below.

FIG. 2A shows an example shuffling operation that is used by the COMM-RAND process 100 to shuffle the nodes 122-160, in accordance with an embodiment. For instance, at step 202, the initial nodes 122-160 from the communities 182-190 are gathered. At step 204, the communities 182-190 themselves are shuffled randomly. Following, at step 206, the nodes within each of the communities 182-190 are shuffled. Thus, based on the shuffling performed in steps 204 and 206, the second community 184 is placed first, and the ordering of the nodes changes from 130-136 to 130, 134, 136, and 132. Then, the fourth community 188 is placed second and the ordering of the nodes is from 150, 148, and 146. The other communities 182, 186, and 190 are also shown in step 206 with their nodes 122-128, 138-144, and 152-160 also shuffled. Therefore, the computing platform induces randomness by shuffling the communities 182-190 as whole blocks and also the content (e.g., the nodes 122-160) within the communities.

In some examples, the shuffling for steps 202-206 may be performed based on a knob (e.g., a community-mixing knob) such as a value, percentage, and/or number. In some embodiments, the community-mixing knob may be used to shuffle at the granularity of single communities, and/or multiple communities, which may be specified by the knob. For instance, the computing platform may obtain a percentage (e.g., the community-mixing knob may indicate a percentage), which may be user-defined, pre-set and/or determined using one or more algorithms, techniques, processes, and/or methods. For example, the percentage may indicate a percentage of the communities 182-190 that are to be grouped into a super-community (e.g., a super-community that includes two or more communities 182-190). Subsequently, the shuffling may be performed based on the super-community. This is described in further detail in FIG. 2B.

FIG. 2B shows another example shuffling operation that utilizes a community-mixing knob, in accordance with an embodiment. In particular, at step 210, based on the community-mixing knob (e.g., a user-defined percentage indicating 40%), the computing platform may group the communities 182-190 such that 40% of the communities 182-190 are grouped into super-communities. For example, as shown, the communities 182 and 184 from FIG. 2A are grouped into a first super-community 212, the communities 186 and 188 are grouped into a second super-community 214, and the third community 216 is just the fifth community 190. Afterwards, at step 218, the communities 212-216 are shuffled similar to above. At step 220, the contents (e.g., nodes 122-160) within the communities 212-216 are shuffled. For example, in the second super-community 214, the nodes 138-150 are shuffled such that the nodes 138-150 are no longer placed based on their original communities 186 and 188. For instance, the node 148, which is originally from the fourth community 188, is now placed first within the super-community 214. As such, based on the community-mixing knob, the computing platform may first group the communities 182-190 into one or more super-communities, and then shuffle the communities as well as the nodes within the communities.

Afterwards, the computing platform may group the shuffled nodes 122-160 and communities 182-190 into batches (e.g., mini-batches) based on a batch size, which may be pre-defined and/or user-defined. For example, based on a batch size of two, the computing platform may group the shuffled nodes into mini-batches that each equal two nodes. This is described in further detail in FIG. 2C.

FIG. 2C shows the grouping of the shuffled nodes and communities into batches (e.g., mini-batches) based on a batch size, in accordance with an embodiment. For example, referring back to FIG. 2A, after completing step 206, the nodes 122-160 and the communities 182-190 are shuffled. FIG. 2C shows the results 230 from completing step 206. Subsequently, based on the batch size (e.g., batch size of two), the computing platform determines the mini-batches 232-250. For instance, the first mini-batch 232 may include the first two nodes 130 and 134 after the shuffling, the second mini-batch 234 may include the next two nodes 136 and 132, and so on. Furthermore, as shown, one or more mini-batches such as mini-batch 238 may include nodes from different communities. For instance, mini-batch 238 includes nodes 146 and 158 from the fourth and fifth communities 188 and 190. As the community-mixing knob is increased from 0% to a higher percentage, such as 40% that is shown in FIG. 2B, more mini-batches may include nodes from different original communities 182-190. Thus, this allows for more randomness to be included, which as mentioned above, allows for improved accuracy and convergence while still offering great run-time performance.

After creating the mini-batches 232-250, the nodes 122-160 within each mini-batch may be referred to as root nodes. For instance, the mini-batch 232 includes two root nodes, which are nodes 130 and 134. Thus, based on the shuffling of the communities and content within the communities, the computing platform performs a biased mapping of the root nodes to the batches (e.g., mini-batches).

In other words, conventional baseline mini-batching approaches randomly and uniformly distribute the nodes of the training set across mini-batches. Specifically, during each training epoch, the contents of the training set are shuffled in a uniform random manner and then the elements of the shuffled set are mapped to batches. With uniform randomization, the root nodes within each mini-batch often belong to different communities. This may be sub-optimal for data reuse as the cache locality benefits of reordering primarily comes from processing members of a community together. In contrast, based on not randomizing the training set before mapping the root nodes to batches, the root nodes within the batches are all mostly from the same community and the partitioning of root nodes to batches is static across all training epochs. While great for data reuse and per-epoch runtime, such a scheme may suffer from poor convergence.

Aiming to find a proper balance between randomization and community awareness in the root node partitioning step, embodiments of the present disclosure utilize step 104 of the COMM-RAND process 100 to perform community-aware randomization of the training set before mapping the root nodes to mini-batches. Specifically, within the training set, the COMM-RAND process 100 treats each community as a block and then applies two levels of randomization: (1) shuffling the communities around as whole blocks, and (2) shuffling the contents within each community block. This constrained form of randomization may result in the root nodes of each mini-batch to mostly belonging to the same community (e.g., similar to the no randomization policy) while also ensuring that the root nodes of each batch are shuffled every epoch (e.g., similar to uniform randomization).

Additionally, and/or alternatively, to allow users to vary the level of community structure-bias and randomness during mini-batch creation, embodiments of the present disclosure may utilize a knob (e.g., the community mixing knob described above). For instance, instead of restricting randomization at the granularity of a single community, embodiments of the present disclosure allow for a fixed number of communities to be mixed to form a super-community and then restrict randomization to within the super-community boundary. Increasing the number of communities that are mixed increases the amount of randomization and reduces the community-bias during mini-batching and vice versa. In order to perform community-aware biased root selection, embodiments of the present disclosure may utilize the community information of each node in the graph that may be available after performing community-based reordering. As such, in summary, the community mixing knob for controlling the community structure bias in partitioning the root nodes may be the number of communities to mix before randomization (e.g., value ranges from “0” to the number of communities in the training set).

Returning to FIG. 1A, after performing biased mapping of the root nodes to the batches, at step 106, the computing platform performs biased neighborhood sampling to construct sub-graphs. For example, based on a fan-out value and the number of layers within the GNN, the computing platform may perform a biased neighborhood sampling, and then construct sub-graphs based on the sampling. This is described in FIG. 2D below.

FIG. 2D shows an example of the COMM-RAND process 100 performing biased neighborhood sampling to construct a sub-graph 260, in accordance with an embodiment. For instance, the computing platform may construct a sub-graph for each mini-batch that was determined at step 104. FIG. 2D shows the sub-graph 260 that was constructed for the mini-batch 232. For example, the root nodes of the mini-batch 232 are nodes 130 and 134, which is shown by the root layer 262. Then, based on the fan-out number (e.g., two in the example shown in FIG. 2D), the computing platform may sample nodes associated with the root nodes 130 and 134. For instance, referring back to FIG. 1B, the node 130 is connected to node 128 and 132-136. Based on the fan-out number of two, the computing platform may randomly select two nodes from the four nodes 128 and 132-136. Furthermore, instead of a mere random selection, the COMM-RAND process 100 and step 106 may use a bias (e.g., a sampling bias) such that the intra-connections are sampled more frequently than the inter-connections. For instance, in FIG. 1B, the connections between the node 130 that are within the same community as node 130 (e.g., the community 184) are the intra-connections. Thus, the connections between node 130 and nodes 132-136 are intra-connections. A connection between node 130 and a node from a different community (e.g., the node 128 that is from the first community 182) is an inter-connection. Therefore, based on the bias, intra-community edges (e.g., connections between node 130 and the nodes 132-136) are more likely to be sampled based on the bias than the inter-community edges (e.g., the connection between the node 130 and the node 128).

In some instances, the bias may be based on a neighbor-sampling knob, which may indicate a value, number, and/or percentage. For instance, the computing platform may obtain a neighbor-sampling knob indicating a value of 0.9, which indicates that the sampling has a 90% chance to select an intra-connection (e.g., one of the nodes 132-136) and an 10% chance to select an inter-connection (e.g., the node 130). In other words, the intra-connection may be the neighbor-sampling knob value (p) and the inter-connection may be one minus the neighbor-sampling knob value (e.g., 1−p). Thus, based on the fan-out (e.g., two) and the bias, the computing platform may determine two nodes that neighbor the node 130. As such, in FIG. 2D, the two nodes that are sampled are nodes 132 and 136. Similarly, the computing platform samples the other root node 134 to obtain nodes 136 and 140. For example, the neighboring nodes to node 134 are nodes 130, 136, and 140. Further, given the inter-connection between node 134 and 140, the bias causes the frequency of sampling the node 140 to be significantly lower (e.g., below 50%). As such, in FIG. 2D, the computing platform samples the neighboring nodes 130, 136, and 140 for root node 134 and obtains the nodes 136 and 140. The dashed line between node 134 and 140 indicates an inter-connection. Therefore, given the three nodes that were sampled that neighbor the root nodes 130 and 134, the three sampled nodes are nodes 132, 136, and 140, which are shown in the first layer 264. Given that both root nodes 130 and 134 sampled node 136, the first layer 264 includes only three nodes 132, 136, and 140 rather than four nodes if both root nodes did not sample the same node. Following, each of these nodes 132, 136, and 140 may be sampled to obtain two additional nodes each, and the unique nodes 136, 130, 134, 138, and 142 are shown in the second layer 266. In some examples, the bias may remain the same for each sampling step. For instance, once the Level-1 neighbors (e.g., the first layer 264 that includes the nodes 132, 136, and 140) are sampled, then the same biased selection is applied for each of the neighbors to obtain the Level-2 neighbors (e.g., the second layer 266). In other words, this is a recursive process and thus, the connections between the node 140 and the nodes 138, 142 are intra-connections.

In some embodiments, the sampling of the root nodes (e.g., the nodes 130 and 134 from the root layer 262) may be allowed in subsequent layers of the sub-graph (e.g., depending on the bias values, the second layer 266 may include the root nodes 130 and 134). In other words, in some examples, based on the sampling, the root nodes 130 and 134 may be included in the root node layer 262 and may further be repeated in a subsequent layer (e.g., the second layer 266).

The number of layers (e.g., the layers 264 and 266) after the root layer 262 may be based on the layers of the GNN. For example, as shown, the GNN to be trained may include two layers, and therefore, FIG. 2D shows two layers 264 and 266 after the root layer 262.

In addition, the community-mixing knob and the neighbor-sampling knob that are used for steps 104 and 106 may be any value, percentage, and/or number. For instance, in some embodiments, the community-mixing knob may be 50%, which indicates that the computing platform may group 50% of the communities into super-communities. In some embodiments, the neighbor-sampling knob may indicate a value between 0.5 and 1, such as a value of 0.9. A value of 0.9 indicates that a 90% chance to select a node that is intra-connected to the root node (e.g., node 130) or subsequent node (e.g., node 132 in the first layer 264), and a 10% chance to select a node that is inter-connected to the root node or subsequent node.

In other words, once the root nodes of each mini-batch are known, step 106 is used to traverse the L-hop neighborhood of the root nodes (for a L-layer GNN) and sample a subset of the neighbors to form the sub-graph (e.g., sub-graph 260) associated with each batch. In conventional techniques, the neighbors may be sampled in a uniform random manner where each neighboring node has an equal likelihood of being selected. Consequently, the sub-graph with uniform random neighbor selection includes nodes spanning multiple communities, which increases the batch's data footprint and increases cache pressure. A community-biased sampling approach (e.g., step 106 of the COMM-RAND process 100) differentiates between intra-and inter-community edges and samples neighbors belonging to the same community with higher probability. In addition, a neighbor-sampling knob may be used to control the community structure bias during neighborhood sampling. The neighbor-sampling knob may indicate a value of ranges from “0” to “1” where a value of “0.5” may indicate an equal likelihood of selecting all neighbors and a value of “1” may indicate to only select neighbors from the same community.

Referring to back to FIG. 1A, after constructing the sub-graphs for each of the mini-batches such as mini-batches 232-250 (e.g., after constructing ten sub-graphs), at step 108, the computing platform trains the GNN using the sub-graphs. For example, the computing platform may perform one epoch of training the GNN using the constructed sub-graphs. For instance, the computing platform may determine a number of epochs to train the GNN (e.g., train the GNN by a set number of training epochs such as for 1,000 epochs or train the GNN until a convergence criteria is satisfied). For each epoch, the computing platform may perform steps 104 and 106 to induce randomness and generate the sub-graphs for each of the mini-batches. After completing each epoch (e.g., training the GNN using a sub-graph for a mini-batch), a backward pass may be performed to update the weights. Then, after using each of the sub-graphs from the mini-batches (e.g., the ten sub-graphs for the ten mini-batches 232-250), an epoch may be completed. The process 100 may loop back to block 104 and 106 to generate additional sub-graphs, and further train the GNN using the same training set until the number of epochs is reached or until the convergence criteria is satisfied.

In other words, based on the loop shown in FIG. 1A (e.g., looping back to block 104), a training epoch may include performing blocks 104, 106, and 108. For example, at every training epoch (e.g., every loop), the COMM-RAND process 100 may construct mini-batches and sub-graphs. In other examples, block 108 may loop back to itself. As such, each instance that block 108 loops back to itself may be a training epoch (e.g., a forward and backward pass). However, because blocks 104 and 106 are outside of the loop (e.g., not included in the loop), the mini-batches/subgraphs are constructed at the beginning (e.g., prior to performing the training epochs).

To put it another way, a user may define a training epoch parameter such as 1000 epochs. Based on the loop shown in FIG. 1A (e.g., looping back to block 104), each of the 1000 epochs may include performing steps 104 and 106 as well as 108 to perform biased mapping of the root nodes to batches and biased neighborhood sampling to construct the sub-graphs. Based on step 108 looping back to itself, the computing platform may perform steps 104 and 106 such that all of the mini-batches and subgraphs are constructed first. Then, the computing platform may perform block 108 for 1000 epochs based on the previously constructed mini-batches and subgraphs.

Additionally, and/or alternatively, instead of using the two extremes described above, the computing platform may perform steps 104 and 106 to construct mini-batches and subgraphs for a set of the total training epochs (e.g., a set of “N” epochs). For instance, based on the total epochs being 1000 and the set of epochs “N” being defined at 50, the computing platform may perform steps 104 and 106 to construct mini-batches and subgraphs for the first set of 50 epochs, and then perform 50 training epochs of step 108 for training the GNN. Afterwards, another set of mini-batches and subgraphs may be constructed for the next set of 50 epochs, and then step 108 may be performed for training the GNN for the next 50 training epochs. This may continue until reaching the total number of training epochs (e.g., 1000 training epochs).

In some examples, instead of using a total number of training epochs criteria (e.g., performing the 1000 training epochs that are described above), the computing platform may use a convergence criteria to determine when to stop training the GNN. For instance, the computing platform may receive user input indicating a model quality threshold (e.g., the convergence criteria), and the computing platform may train the GNN until the model quality threshold is satisfied, which may result in an arbitrary number of training epochs being performed. As such, because the COMM-RAND process 100 introduces a performance versus convergence tradeoff (e.g., due to the selection of the community-mixing knob and neighbor-sampling knob), the convergence criteria may be useful to perform sufficient training of the GNN.

As such, in summary, embodiments of the present disclosure may perform step 104, which describes a computing platform performing biased mapping of root nodes to batches to obtain the mini-batches such as the mini-batches 232-250 that are obtained after shuffling the communities 182-190 and nodes 122-160 within the communities 182-190. Additionally, and/or alternatively, embodiments of the present disclosure may perform step 106, which describes a computing platform performing biased neighborhood sampling to construct sub-graphs such as the sub-graph 260 from FIG. 2D.

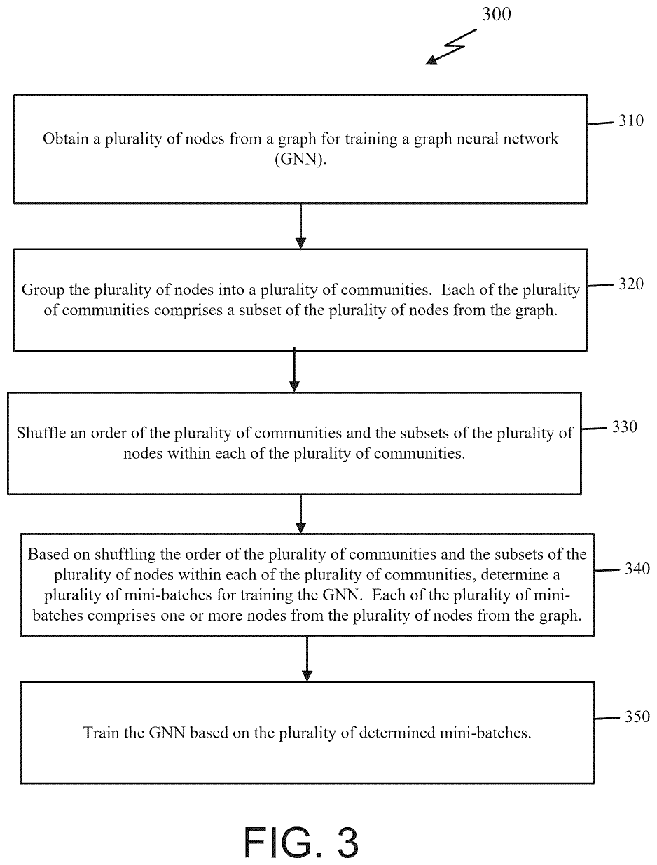

FIG. 3 provides a flow diagram illustrating a method 300 for performing efficient training of a GNN using graph structure-aware randomized mini-batching, in accordance with an embodiment. Each block of method 300, described herein, comprises a computing process that may be performed using any combination of hardware, firmware, and/or software. For instance, various functions may be carried out by a processor executing instructions stored in memory. The method 300 may be executed by any one system, or any combination of systems, including, but not limited to, those described herein (e.g., the computing platform described above). Furthermore, persons of ordinary skill in the art will understand that any system that is capable of performing method 300 is within the scope and spirit of embodiments of the present disclosure.

At step 310, a plurality of nodes are obtained from a graph for training a GNN.

At step 320, the plurality of nodes are grouped into a plurality of communities. Each of the plurality of communities comprises a subset of the plurality of nodes from the graph.

At step 330, an order of the plurality of communities and the subsets of the plurality of nodes within each of the plurality of communities is shuffled. In an embodiment, shuffling the order of the plurality of communities and the subsets of the plurality of nodes within each of the plurality of communities comprises shuffling the order of the plurality of communities and subsequent to shuffling the order of the plurality of communities, shuffling the subsets of the plurality of nodes within each of the plurality of communities.

In an embodiment, shuffling the order of the plurality of communities and the subsets of the plurality of nodes within each of the plurality of communities comprises: obtaining a community-mixing knob; determining, based on the community-mixing knob, a first subset of the plurality of communities to be combined into one or more super-communities and a second subset of the plurality of communities to remain as individual communities; combining the first subset of the plurality of communities into the one or more super-communities; and shuffling the one or more super-communities and the second subset of the plurality of communities that remain as the individual communities, wherein determining the plurality of mini-batches for training the GNN is based on the shuffling of the one or more super-communities and the second subset of the plurality of communities. In an embodiment, shuffling the order of the plurality of communities and the subsets of the plurality of nodes within each of the plurality of communities further comprises: subsequent to combining the first subset of the plurality of communities into the one or more super-communities, shuffling the nodes within the one or more super-communities, and wherein determining the plurality of mini-batches for training the GNN is further based on shuffling the nodes within the one or more super-communities. In an embodiment, the community-mixing knob indicates a percentage of communities from the plurality of communities that are to be combined into the one or more super-communities.

At step 340, based on shuffling the order of the plurality of communities and the subsets of the plurality of nodes within each of the plurality of communities, a plurality of mini-batches for training the GNN are determined. Each of the plurality of mini-batches comprises one or more nodes from the plurality of nodes from the graph. In an embodiment, determining the plurality of mini-batches for training the GNN comprises: obtaining a batch size for training the GNN; and populating the one or more nodes from the plurality of nodes from the graph into each of the plurality of mini-batches based on the batch size and an order of the plurality of nodes that is based on shuffling the order of the plurality of communities and the subsets of the plurality of nodes within each of the plurality of communities.

At step 350, the GNN is trained based on the plurality of determined mini-batches.

In an embodiment, the method 300 further comprises: reordering a numbering of the plurality of nodes from the graph to assign a node identifier (ID) to each of the plurality of nodes based on grouping the plurality nodes into the plurality of communities, and wherein shuffling the order of the plurality of communities and the subsets of the plurality of nodes within each of the plurality of communities is based on reordering the numbering of the plurality of nodes.

In an embodiment, the method 300 further comprises: constructing, based on a sampling bias, a sub-graph for each of the plurality of mini-batches to obtain a plurality of sub-graphs, wherein training the GNN is based on the plurality of sub-graphs. In an embodiment, the plurality of mini-batches comprises a first mini-batch that comprises a first node from the plurality of nodes from the graph, and wherein constructing the sub-graph for the first mini-batch comprises: sampling nodes that neighbor the first node from the first mini-batch based on the sampling bias to obtain one or more first neighborhood nodes, wherein the sampling bias indicates a bias for sampling intra-connections to the first node instead of inter-connections to the first node; and constructing the sub-graph for the first mini-batch based on the first node and the one or more first neighborhood nodes.

In an embodiment, constructing the sub-graph for the first mini-batch is further based on a fan-out parameter, and wherein the sub-graph for the first mini-batch comprises a plurality of layers that are based on a number of layers of the GNN to be trained. In an embodiment, constructing the sub-graph for the first mini-batch further comprises: obtaining a neighbor-sampling knob comprising the sampling bias, wherein the sampling bias indicates a first sampling rate and a second sampling rate, wherein the first sampling rate indicates a first percentage to sample nodes that are within a same community as the first node and the second sampling rate indicates a second percentage to sample nodes that are from a different community than the first node.

In an embodiment, at least one of steps 310-350 are performed on a server or in a data center. In an embodiment, at least one of steps 310-350 is performed within a cloud computing environment. In an embodiment, at least one of steps 310-350 is performed for training, testing, or certifying the GNN, which is employed in a machine, robot, or autonomous vehicle. In an embodiment, at least one of steps 310-350 is performed on a virtual machine comprising a portion of a graphics processing unit.

In contrast to conventional systems, such as those described above, embodiments of the present disclosure describe a COMM-RAND process 100 that may include: 1) structure-aware randomness in root node ordering that biases mini-batches toward computationally efficient patterns while maintaining sufficient randomization for convergence (e.g., performing step 104 and shuffling an order of the plurality of communities and/or the nodes within each of the plurality of communities), and 2) adaptive community-aware neighborhood sampling that controls the level of structural bias when expanding sub-graphs from root nodes (e.g., performing step 106 and constructing a sub-graph for each of the plurality of mini-batches to obtain a plurality of sub-graphs based on a sampling bias that indicates a bias for sampling intra-connections instead of inter-connections). By using the COMM-RAND process 100, this enables the ability to navigate the interplay between pure randomness and pure structural awareness, thus leading to more efficient training while maintaining nearly identical accuracy.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

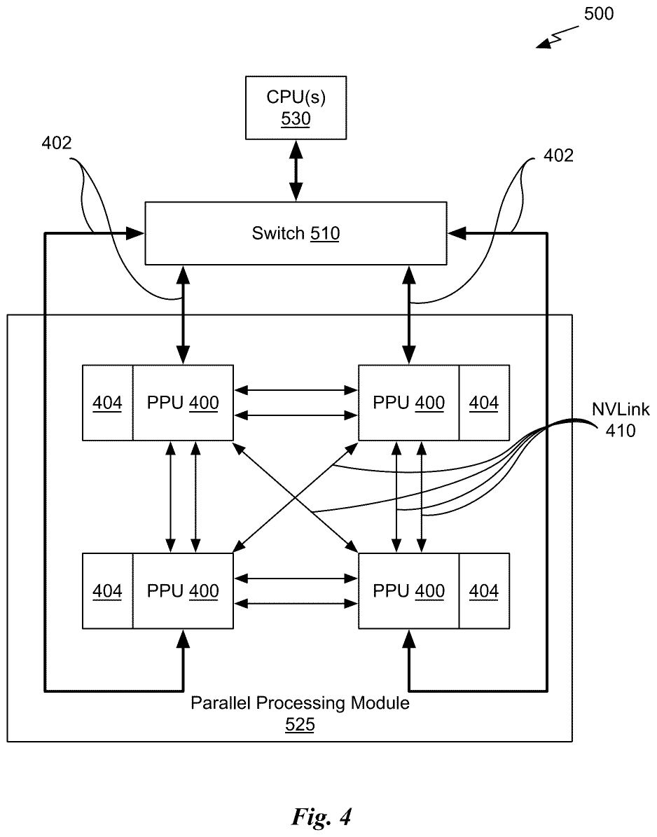

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

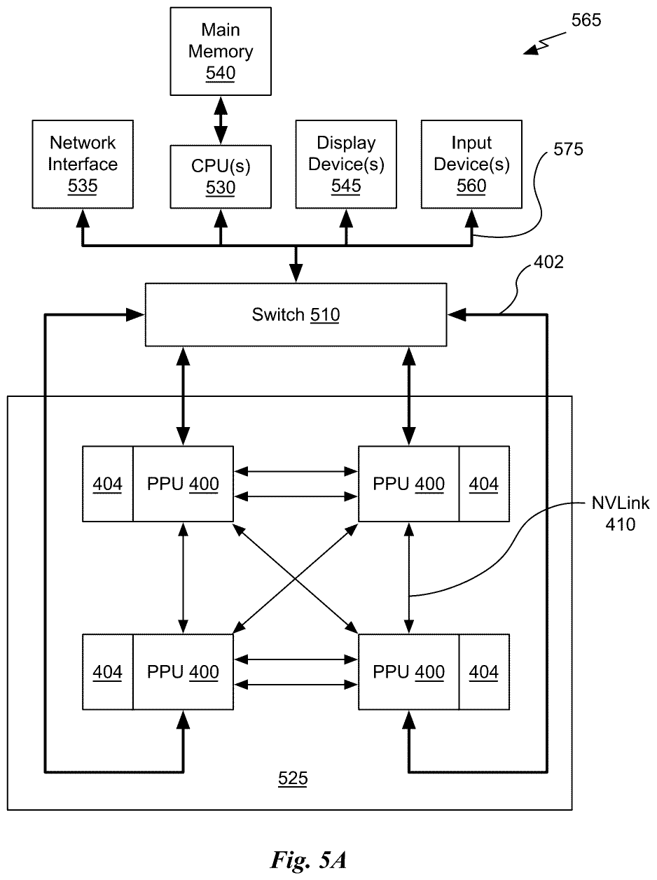

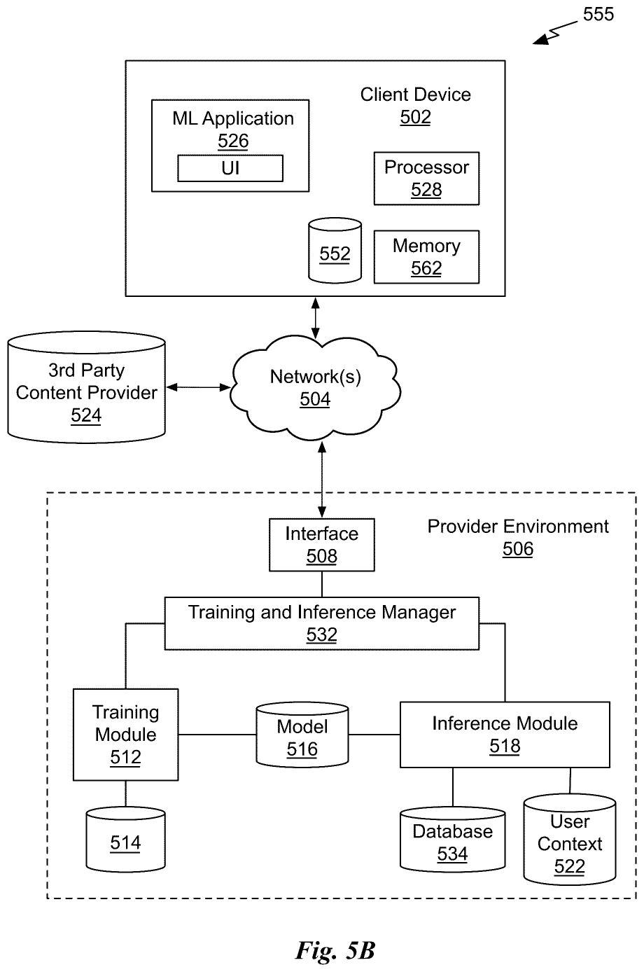

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system.

Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

### Example Streaming System

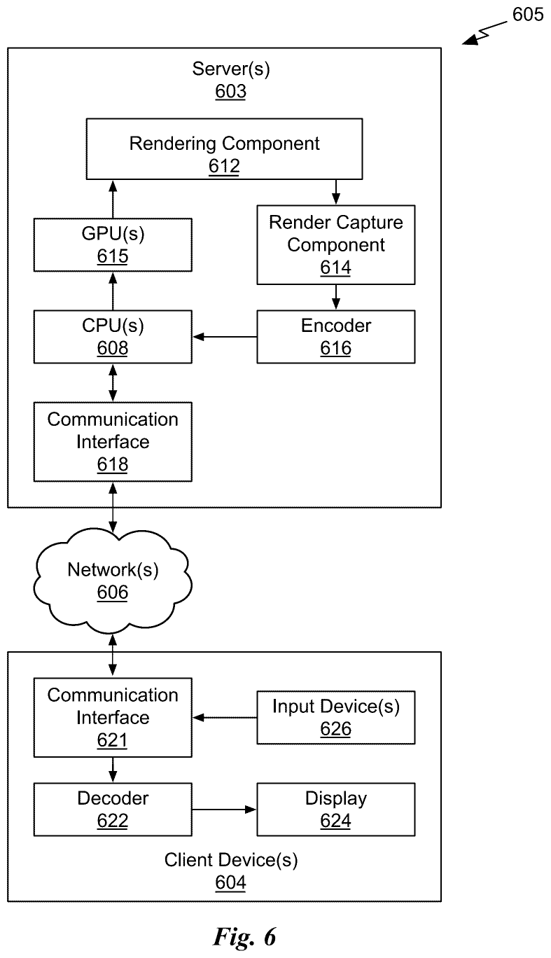

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for performing efficient training of a graph neural network (GNN) using graph structure-aware randomized mini-batching, comprising:
obtaining a plurality of nodes from a graph for training the GNN;
grouping the plurality of nodes into a plurality of communities, wherein each of the plurality of communities comprises a subset of the plurality of nodes from the graph;
shuffling an order of the plurality of communities and the subsets of the plurality of nodes within each of the plurality of communities;
based on shuffling the order of the plurality of communities and the subsets of the plurality of nodes within each of the plurality of communities, determining a plurality of mini-batches for training the GNN, wherein each of the plurality of mini-batches comprises one or more nodes from the plurality of nodes from the graph; and
training the GNN based on the plurality of determined mini-batches.

2. The computer-implemented method of claim 1, wherein shuffling the order of the plurality of communities and the subsets of the plurality of nodes within each of the plurality of communities comprises:
shuffling the order of the plurality of communities; and
subsequent to shuffling the order of the plurality of communities, shuffling the subsets of the plurality of nodes within each of the plurality of communities.

3. The computer-implemented method of claim 1, wherein shuffling the order of the plurality of communities and the subsets of the plurality of nodes within each of the plurality of communities comprises:
obtaining a community-mixing knob;
determining, based on the community-mixing knob, a first subset of the plurality of communities to be combined into one or more super-communities and a second subset of the plurality of communities to remain as individual communities;
combining the first subset of the plurality of communities into the one or more super-communities; and
shuffling the one or more super-communities and the second subset of the plurality of communities that remain as the individual communities, wherein determining the plurality of mini-batches for training the GNN is based on the shuffling of the one or more super-communities and the second subset of the plurality of communities.

4. The computer-implemented method of claim 3, wherein shuffling the order of the plurality of communities and the subsets of the plurality of nodes within each of the plurality of communities further comprises:
subsequent to combining the first subset of the plurality of communities into the one or more super-communities, shuffling the nodes within the one or more super-communities, and wherein determining the plurality of mini-batches for training the GNN is further based on shuffling the nodes within the one or more super-communities.

5. The computer-implemented method of claim 3, wherein the community-mixing knob indicates a percentage of communities from the plurality of communities that are to be combined into the one or more super-communities.

6. The computer-implemented method of claim 1, further comprising:
reordering a numbering of the plurality of nodes from the graph to assign a node identifier (ID) to each of the plurality of nodes based on grouping the plurality nodes into the plurality of communities, and wherein shuffling the order of the plurality of communities and the subsets of the plurality of nodes within each of the plurality of communities is based on reordering the numbering of the plurality of nodes.

7. The computer-implemented method of claim 1, wherein determining the plurality of mini-batches for training the GNN comprises:
obtaining a batch size for training the GNN; and
populating the one or more nodes from the plurality of nodes from the graph into each of the plurality of mini-batches based on the batch size and an order of the plurality of nodes that is based on shuffling the order of the plurality of communities and the subsets of the plurality of nodes within each of the plurality of communities.

8. The computer-implemented method of claim 1, further comprising:
constructing, based on a sampling bias, a sub-graph for each of the plurality of mini-batches to obtain a plurality of sub-graphs, wherein training the GNN is based on the plurality of sub-graphs.

9. The computer-implemented method of claim 8, wherein the plurality of mini-batches comprises a first mini-batch that comprises a first node from the plurality of nodes from the graph, and wherein constructing the sub-graph for the first mini-batch comprises:
sampling nodes that neighbor the first node from the first mini-batch based on the sampling bias to obtain one or more first neighborhood nodes, wherein the sampling bias indicates a bias for sampling intra-connections to the first node instead of inter-connections to the first node; and
constructing the sub-graph for the first mini-batch based on the first node and the one or more first neighborhood nodes.

10. The computer-implemented method of claim 9, wherein constructing the sub-graph for the first mini-batch is further based on a fan-out parameter, and wherein the sub-graph for the first mini-batch comprises a plurality of layers that are based on a number of layers of the GNN to be trained.

11. The computer-implemented method of claim 8, wherein constructing the sub-graph for the first mini-batch further comprises:
obtaining a neighbor-sampling knob comprising the sampling bias, wherein the sampling bias indicates a first sampling rate and a second sampling rate, wherein the first sampling rate indicates a first percentage to sample nodes that are within a same community as the first node and the second sampling rate indicates a second percentage to sample nodes that are from a different community than the first node.

12. The computer-implemented method of claim 1, wherein at least one of the steps of obtaining, grouping, shuffling, determining, and training are performed on a server or in a data center.

13. The computer-implemented method of claim 1, wherein at least one of the steps of obtaining, grouping, shuffling, determining, and training are performed within a cloud computing environment.

14. The computer-implemented method of claim 1, wherein at least one of the steps of obtaining, grouping, shuffling, determining, and training are performed for training, testing, or certifying the GNN, which is employed in a machine, robot, or autonomous vehicle.

15. The computer-implemented method of claim 1, wherein at least one of the steps of obtaining, grouping, shuffling, determining, and training is performed on a virtual machine comprising a portion of a graphics processing unit.

16. A computing platform for performing efficient training of a graph neural network (GNN) using graph structure-aware randomized mini-batching, comprising:
one or more processors; and
a non-transitory computer-readable medium having processor-executable instructions stored thereon, wherein the processor-executable instructions, when executed by the one or more processors, facilitate:
obtaining a plurality of nodes from a graph for training the GNN;
grouping the plurality of nodes into a plurality of communities, wherein each of the plurality of communities comprises a subset of the plurality of nodes from the graph;
shuffling an order of the plurality of communities and the subsets of the plurality of nodes within each of the plurality of communities;
based on shuffling the order of the plurality of communities and the subsets of the plurality of nodes within each of the plurality of communities, determining a plurality of mini-batches for training the GNN, wherein each of the plurality of mini-batches comprises one or more nodes from the plurality of nodes from the graph; and
training the GNN based on the plurality of determined mini-batches.

17. The computing platform of claim 16, wherein shuffling the order of the plurality of communities and the subsets of the plurality of nodes within each of the plurality of communities comprises:
shuffling the order of the plurality of communities; and
subsequent to shuffling the order of the plurality of communities, shuffling the subsets of the plurality of nodes within each of the plurality of communities.

18. The computing platform of claim 16, wherein the processor-executable instructions, when executed by the one or more processors, further facilitate:
constructing, based on a sampling bias, a sub-graph for each of the plurality of mini-batches to obtain a plurality of sub-graphs, wherein training the GNN is based on the plurality of sub-graphs.

19. A non-transitory computer-readable medium having processor-executable instructions stored thereon for performing efficient training of a graph neural network (GNN) using graph structure-aware randomized mini-batching, wherein the processor-executable instructions, when executed, facilitate:
obtaining a plurality of nodes from a graph for training the GNN;
grouping the plurality of nodes into a plurality of communities, wherein each of the plurality of communities comprises a subset of the plurality of nodes from the graph;
shuffling an order of the plurality of communities and the subsets of the plurality of nodes within each of the plurality of communities;
based on shuffling the order of the plurality of communities and the subsets of the plurality of nodes within each of the plurality of communities, determining a plurality of mini-batches for training the GNN, wherein each of the plurality of mini-batches comprises one or more nodes from the plurality of nodes from the graph; and
training the GNN based on the plurality of determined mini-batches.

20. The non-transitory computer-readable medium of claim 19, wherein the processor-executable instructions, when executed, further facilitate:
constructing, based on a sampling bias, a sub-graph for each of the plurality of mini-batches to obtain a plurality of sub-graphs, wherein training the GNN is based on the plurality of sub-graphs.
